(19) United States
(12) Patent Application Publication
(10) Pub. No.: US 2004/0153335 A1
(43) Pub. Date: Aug. 5, 2004

(54) Web-based method and system for managing public relations functions

(76) Inventor: Stephen W.T. O'Keeffe, Alexandria, VA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/768,143

(22) Filed: Feb. 2, 2004

Related U.S. Application Data
(60) Provisional application No. 60/444,197, filed on Feb. 3, 2003.

(51) Int. Cl. G06F 17/60

(52) U.S. Cl. 705/1

(57) ABSTRACT

A method including generating a public relations database configured to store information related to at least two of client identifiers, employees, employee schedules, contacts, call reports and employee timesheets, creating a user interface configured to enable a user to at least one of enter, edit, search and view client information, employee information, employee schedules, contacts, call reports, and timesheets; and building editorial opportunity matrices to support each client account.

### CROSS-REFERENCE TO RELATED APPLICATION

This application claims priority under 35 U.S.C. 119(e) to U.S. Provisional Application Serial No. 60/444,197, filed Feb. 3, 2003 and entitled “Web-Based Method and System for Managing Public Relations Function,” which is incorporated herein by reference in its entirety.

### BACKGROUND OF THE INVENTION

1. Field of the Invention

The invention relates to a method and system for managing organizational functions, and, more particularly to method and system for managing the functions of a public relations firm.

2. Description of the Related Art

Public relations agencies are challenged to deliver a consistent level of service across their account base. In-house functions/departments face parallel challenges in ordering and structuring processes and deliverables. Focusing on the agency business, traditional organizations segment staff into account teams, with each team working independently and often, competitively. Traditionally, the results produced have been 100 percent dependent on the skills of the particular account team/practitioner. Public relations practitioners have been unable to effectively capture lessons learned or even develop common tools to help transfer knowledge and best practices from experienced to less experienced staff members.

Several companies have attempted to build systems to help improve the situation. There are currently three commercial-off-the-shelf software solutions that fall under this broad category: MediaMap (www.mediamap.com); Press Access (www.pressaccess.com); and Vocus (www.vocus.com).

These tools are essentially front-end templates designed to sell press, analyst, and trade show contact databases. They do not, however, effectively enable agencies/in-house departments to improve their ability to help their staff members stay on top of details and action items, improve management visibility into project status, drive knowledge sharing or help the agency/department capture lessons learned, or offer access to the full organizational toolkit.

Traditional public relations firms exhibit a common core of deficiencies as follows:

1. Common knowledge and tools are tied to a physical location and are difficult to access outside the office environment.

2. Each employee has to organize information and manage time in an independent fashion. More experienced personnel are exponentially more effective at keeping track of details and following through on open action items. Open action items and project status details are difficult to exchange, limiting management visibility.

3. Public relations agencies/in-house departments are driven to manage multiple, similar contact lists independently. As a result, changes made on one list are not translated to other lists, and overall list quality is very poor. There is no mechanism for leveraging all staff resources to scrub a central list/database.

4. Individual account teams are forced to replicate the identical editorial calls, thereby annoying reporters and lowering overall agency or departmental efficiency levels. In addition, traditional public relations processes leave task and time management up to individual teams and individuals, with widely varying results.

5. Real-time budget management capabilities cannot be delivered to managers tracking multiple teams across multiple accounts and multiple cost centers within each account.

6. Easy, quick billability assessment cannot be enabled.

7. Productivity and information are tied to physical locations. This is in direct contrast to the realities of the public relations profession, which requires staff members to frequently attend out of the office meetings, events, press tours, etc.

8. Agency and departmental tools and resources cannot be centralized. Typically, some employees are aware of the tools and use them, others are not aware of them or are unable to find passwords. This raises staff members' frustration level, reduces efficiency, and hampers the agency's/in-house department's ability to produce results efficiently.

9. Effective client/project/internal customer reporting is not supported. Status reports are time consuming, labor intensive, and often error-ridden.

10. A central knowledge repository cannot be provided. Employees are constantly challenged to find resources and templates.

11. Employee information and human resources (HR) information is stored in paper-based format.

12. Employees are required to maintain individual calendars on their desktops, eliminating the potential to check one another's availability unless the other individual is present.

13. Paper based timesheets are used to track time, eliminating the possibility of real-time visibility into budget and productivity status.

14. Client/project/internal customer information is stored centrally, thereby hampering the agency's/department's ability to be responsive if the primary account team is unreachable.

### SUMMARY OF THE INVENTION

The present invention is a web-based, thin client software application that is configured to manage the full spectrum of the public relations business—incorporating functionality around key functions, common tools, and including qualitative operational efficiency and productivity tracking.

In an embodiment of the invention a method includes generating a public relations database configured to store information related to at least two of client identifiers, employees, employee schedules, contacts, call reports and employee timesheets, creating a user interface configured to enable a user to at least one of enter, edit, search and view client information, employee information, employee schedules, contacts, call reports, and timesheets; and building editorial opportunity matrices to support each client account.

### DESCRIPTION OF THE DRAWINGS

The invention is described with reference to the accompanying drawings.

FIG. 1 illustrates a schematic illustration according to an embodiment of invention.

FIG. 2 illustrates a display of the public relations account console in accordance with an embodiment of the invention.

FIG. 3 illustrates a display for entering a call record in accordance with an embodiment of the invention.

FIGS. 4A and 4B illustrate displays for entering contact information in accordance with an embodiment of the invention.

### DETAILED DESCRIPTION

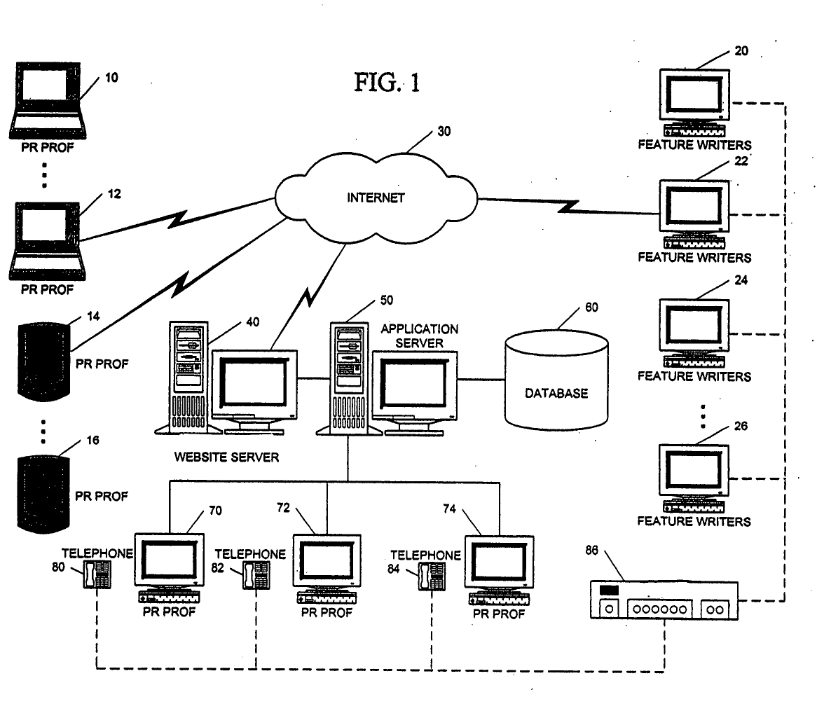

FIG. 1 illustrates one embodiment of a public relations system 10 suitable for implementing the features of the invention. System 10 includes a public relations website server 40, along with an application server 50 and public relations database 60. The public relations database 60 stores call reporting and action items, tracking information, contact information, agency-wide personnel scheduling information, and freelancer call information, as well as other data described below.

For simplicity, the figure shows out-of-office public relations (PR) professionals 10, 12, 14, 16; feature writers 20, 22, 24, 26; and in-office public relations professionals 70, 72, 74. Each feature writer 20, 22, 24, 26 prepares feature articles for at least one of multiple publications. The PR professionals 10, 12, 14 16, 70, 72, 74 contact feature writers/editorial assistants 20, 22, 24, 26 to obtain information on the focus and deadline for each editorial opportunity. The PR professional contacts the feature writer/editorial assistant by telephone 80, 82, 84 by electronic mail or by wireless communications. The out-of-office PR professionals 10, 12, 14 16 can access the public relations website server from individual access devices or computers 102 via a wireless, dial-up connection or dedicated connection over the Internet 30.

Suitable implementations of access devices/computers 102 include devices such as laptop computers, personal computers, wireless telephones, portable workstations, personal data assistants (“PDA's”), pagers, and various other portable electronic communication devices capable of carrying out similar activities. Where such devices are used, PR professionals may utilize conventional methods to provide input.

While disclosed herein as the Internet, the network 30 may be any form of interconnecting network including an intranet, such as a local or wide area network, or an extranet, such as the World Wide Web or the Internet. Network 30 can be physically implemented on a wireless or wired network, on leased or dedicated lines, including a virtual private network (VPN). Network 30 can be any type of communications network, such that computers and wireless devices, whether a laptop, hand-held electronic device or a cellular telephone, can both access databases and systems to retrieve and view information. The invention may be used in conjunction with a wireless operating system such as the Wireless Application Protocol (WAP).

In one embodiment, the system is a WINDOWS based system. In another embodiment, the system is a PALM based system. In yet a further embodiment, the system is a UNIX based system. The system may also be internet-based and generate web-browser and web page data, such as HTML, JavaScript, Java applets, etc.

The access devices 102 used by the PR professionals 10, 12, 14 16, 70, 72, 74 each include a user input/output, a display, and a memory. The access devices 102 are each configured to run software to retrieve and view information from database 60 of the public relations system 10 over network 30. As described below, a user interface rendered on the access device 102 enables users of the system 10 to carry out various activities, including, for example, information retrieval, appointment scheduling, data searches, etc. Hence, access device 102 is a device by which each user of the system can upload, download and/or view information related to a particular function of the PR firm.

Database 60 may be an ODBC-compliant database, such that it is accessible via a variety of database programs. The public relations database 60 is configured to include information such as call reporting and action items for various PR professionals; tracking information as it relates to particular clients of the PR firm; employee contact information; personnel scheduling information; individual and corporate contact information; editorial call management information; freelancer call information; vendor independent online tool access such as Lexis-Nexis, Media Map, Bacons, etc.; human resources (HR) information; internal/external client information; best practice tool and template library, including samples of key documents for employee reference, new product press release sample, biography sample, user success story sample, white paper sample, proposal sample, press tour checklist, etc.; status reports creation; time reporting and budget management functions; and productivity analysis.

The accessibility of the information in database 60 may be dependent upon the display capabilities of the receiving device, individual access rights, and accessibility of the system 10 from various locations.

Although the system 10 may store information related to public relations firms and functions, it may store other information as well. The information may be stored in a single database 60 or multiple databases. For example, system 10 may store any combination of information regarding any of the above-described information in any number of databases 60. Any of the above-described information stored by database 60 may be communicated to access device 102 over network 30 in a conventional manner.

The following description of the operation of system 10 includes the function and interaction of the various users with the remainder of system 10 illustrated in FIG. 1. It is to be understood that the following description is applicable to multiple users and multiple access devices not necessarily illustrated in FIG. 1.

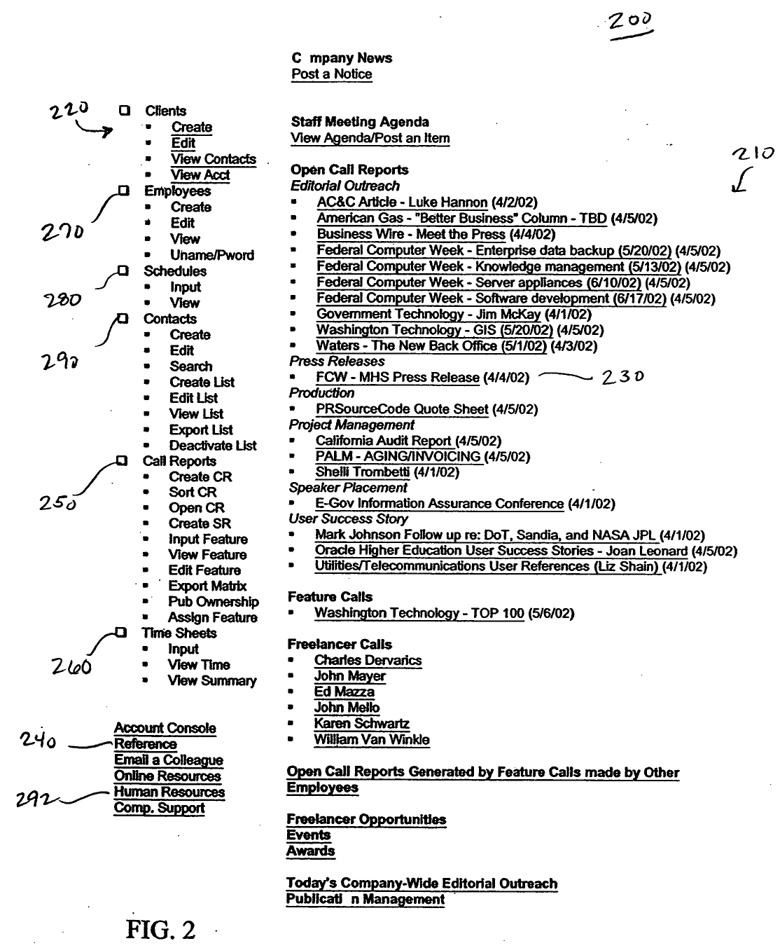

Functionality of the system according to an embodiment of the invention will be described with reference to a practical example and with reference to FIGS. 2, 3, 4A and 4B. FIGS. 2, 3, 4A and 4B illustrate exemplary displays that may be viewed by a user accessing system 10 of the invention.

A PR professional 10, 12, 14, 16 can log on to the web-based public relations software application. The PR professional 10, 12, 14, 16 can review the action items 210 that have appeared on his or her account console 200 as illustrated in FIG. 2. The PR professional 10, 12, 14, 16 can then check their calendar noting key appointments. The individual then might make a number of calls, following up on key open tasks 210 from the account console.

The PR professional 10, 12, 14, 16 may take a call from a reporter for a colleague who is out of the office. The reporter may needs to talk to her colleague's client/internal customer within a short time. The PR professional 10, 12, 14, 16 is able to locate the appropriate contact information via the client/internal customer section 220 of the account console 200 user interface, contact the client/internal customer, and schedule an interview.

The PR professional 10, 12, 14, 16 then might draft a press release. The information about the upcoming press release, including the appropriate deadline is identified in a press release portion 230 of the account console 200. If the PR professional 10, 12, 14, 16 has never written a particular type of press release before, the PR professional 10, 12, 14, 16 can access a template of that type of press release from the public relations software application's reference library (discussed below) via reference library link 240 via the account console user interface 200.

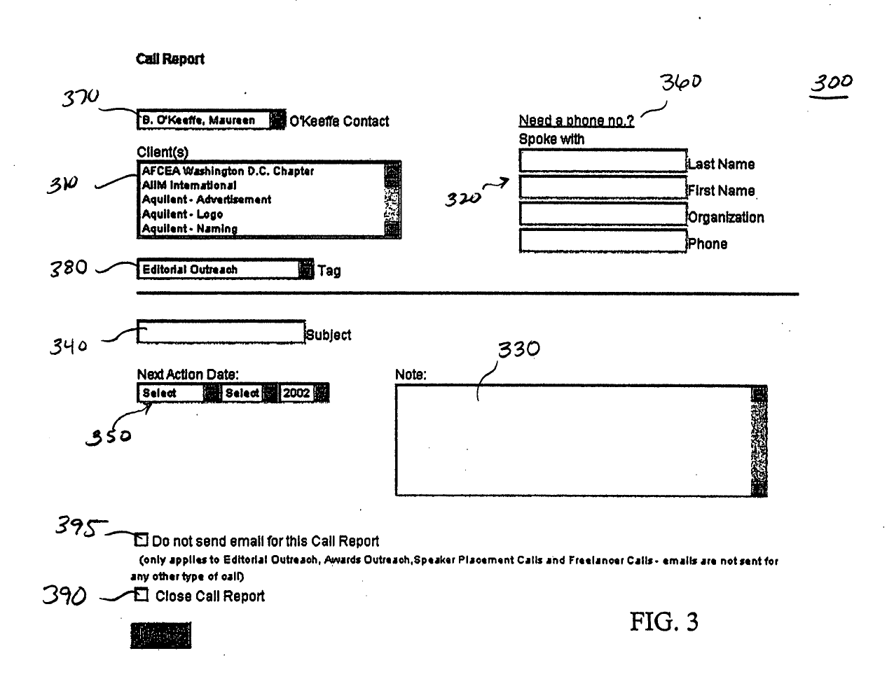

The PR professional 10, 12, 14, 16 can make a number of editorial calendar calls that appeared on the account console 200. For each reporter that the PR professional 10, 12, 14, 16 reaches, they can obtain the focus of the particular article that is to be written, and can update a call report by accessing the call report entry screen through the call report link 250 on the account console 200. A sample call report entry screen 300 is illustrated in FIG. 3.

The call report entry screen allows a user to enter information about a particular call into the system 10. Through the call report screen 300, a user can enter or select a client at block 310, enter call contact information (e.g., name, organization and phone number of person contacted) at blocks 320, can enter notes about the call at note entry block 330, can enter the subject of the call at subject block 340, and can select a next action date at block 350.

As the PR professional 10, 12, 14, 16 closes the call report, the system sends out an e-mail to everyone in the agency/department. The e-mail includes information such as the article focus information. Additionally, the call report appears on the account console of other agency/department staff members who work on other accounts/projects that were associated with that specific call. The efforts of the single employee benefit multiple accounts/projects. In other words, the duplication of efforts is minimized. For example, if two employees had a similar action item to make a particular call, once one of the users completed the call report, the action item would be removed or updated on the account console user interface 200 of the other user.

Using the account console user interface 200, users can access multiple components of the system 10. For example, a user can enter and/or view time sheet information via time sheet link 260. Through the account console, information about employees may be entered, updated and/or viewed via the employee information link 270. Additionally, schedule information may be entered, updated and/or viewed via the schedule link 280. Contacts can be created, edited, search, consolidated, grouped and/or ungrouped via the contact link 290.

If a user is away from their office computer at a remote location, using a wireless device or a remote computer, the employee can log onto the system 10 and obtain any information from the database 60 that could be obtained if connected locally to the database.

Depending upon the access rights/privileges granted to a particular user, the user may have the ability to perform some or all of the tasks and functions possible through the account console 200. For example, while a lower-level employee may only be able to enter their own time sheet information, a supervisor may have the ability to view multiple employees' individual information or a summary of the information of the group/department for which they are responsible. Additionally, a supervisor with greater access rights can view more information about a broader range of clients than a lower-level user.

The system 10 and associate applications are configured to be hosted at a secure, stripped Internet Protocol (IP) address. Consequently, information is completely secure and accessible by only those individuals with the appropriate devices/passwords.

The invention includes a call reporting and action item alert system as discussed above. This rules-driven approach ensures that the firm using the system 10 captures, structures, and categorizes all external interaction in a consistent fashion. Users are required to log a call report 300 any time they engage in an external interaction with a client/in-house customer, member of the press, conference manager, client partner, etc. The system 10 includes a contact information look-up feature, which is accessible directly from the call report. By clicking on a link 360, the user can instantly access the contact database to retrieve a telephone number, e-mail address or other information about a particular individual. This saves time moving back and forth among screens/windows and allows the user to work more quickly.

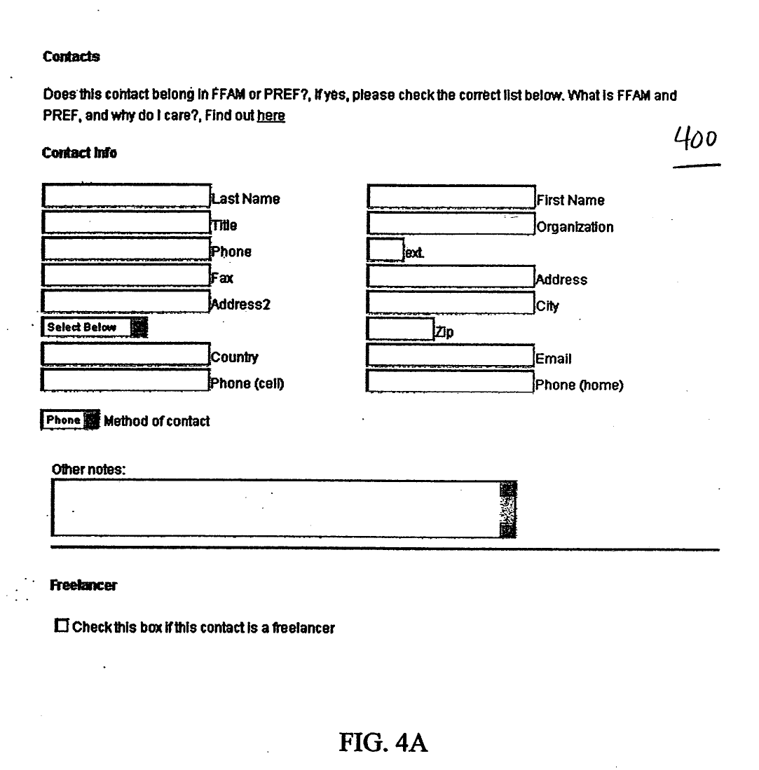

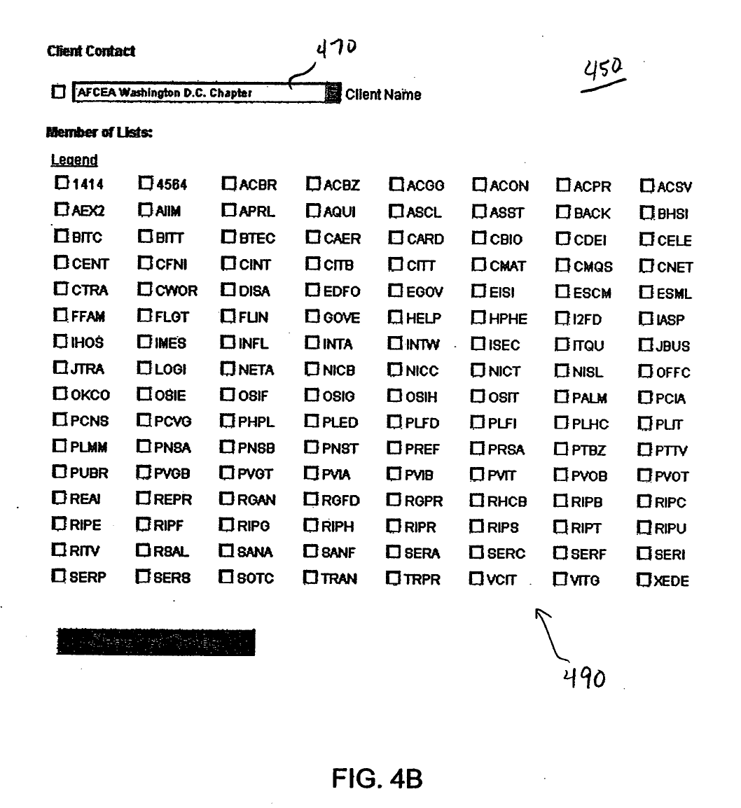

In one example, the user records the contact information for the person with whom they are interacting on the contact information entry screen 400 illustrated in FIG. 4A. Once the call report is complete, the system 10 automatically compares the contact name with that stored in the contact database. If similar contacts exist in the database, the system 10 provides a drop-down menu (not illustrated in FIG. 4A) and allows review of the contact options to determine if the contact is already in the database. If this contact is new to the system, the user confirms that the contact is indeed new, and the system 10 automatically updates the contact database. This process guards against duplicate contacts.

Once the user has entered the contact information, the information from the particular call can be associated with a client/project/in-house customer via the drop-down menu 370 illustrated in FIG. 3. Next, the user can identify a particular category of activity via category menu 380. The activity options are as follows: Strategies and Status Reports; Materials Development; Launch; Press Releases; Editorial Outreach; User Success Story; Partner Relations; Analyst Outreach; Awards Outreach; Speaker Placement; Trade Show Support; Event Management; Production; Project Management; and Freelancer Call.

These categories map directly to the categorization breakdown the system provides in monthly status reports. By setting up the account/project and activity structure in the call report, the agency/department/in-house function reduces the burden associated with generating detailed monthly status reports.

The user notes the content of their external interaction in the call report notes field as discussed above. Importantly, the user must either assign a follow-up date for the next action on the project or elect to close the call report by checking a box 390 indicating that the project is complete. If the project was not complete, the system 10 automatically alerts the user on their account console 200 when it is time to take the next action on a project. The system 200 ties to the calendar, making it impossible, for example, for users to assign a weekend follow up date to a project.

Another aspect of the call report 300 relates to information distribution. Functionality that captures information that is useful to all employees is pushed to each employee via an automated e-mail. This e-mail feature is enabled for components that are useful to all employees, such as editorial outreach and freelancer contacts. Since it often takes numerous attempts to obtain useful information, users can select a “do not e-mail” button 395 as they close the report, until the information is complete.

The system 10 includes a comprehensive contact management system. Users can enter new contacts via the contact entry screen 400 illustrated in FIG. 4A. As illustrated in FIG. 4B, the contact can be associated with one or projects via the client contact entry screen 450. The client contact entry screen includes drop-down menu 470 so that a particular client can be chosen. Once the client is chosen, any number of the associated projects or lists 490 can be selected. When a client is associated with a particular list, any information that is associated with the particular list, is also associated with the client(s) assigned to that list. The contacts can be categorized into at least one of four groups: Clients; Press; Freelancer; Prospect/Friends and Family. The system 10 of the invention includes safeguards to prevent practitioners from entering duplicate contacts as discussed above.

The system of the invention includes a structured editorial matrix and task assignment infrastructure. The system 10 allows the agency/in-house department to build multiple editorial matrices, a chronological editorial feature target pitch list constructed to support each account. Each matrix supports a client, business unit, or project. In this process, the user enters a publication title, feature title, and issue date. The system requires that the user assign a client/internal customer/project to the editorial opportunity. Therefore, all opportunities are assigned to one or more clients/projects/business units or internal customers. The system 10 incorporates a rules-based, lead-time capability. Hence, it recognizes the lead times required for specific publications and automatically assigns a pitch date based on the entered issue date.

The agency/in-house department can assign specific staff members as the responsible individual for specific publications through the system 10. As such, the responsibility for calling for any editorial feature opportunity is automatically assigned to the individual responsible for the publication. Any publications that are not assigned to a particular individual are assigned manually based on various criteria such as relation of the call subject matter to a particular account team. All calls requirements are pushed to the desktop of the assigned user based on the initial pitch date. The calls show up on the account console 200 as and are color-coded as a “green call.” The user can click on the call assignment on their account console 200 and a call report 300 is brought up on their graphical user interface. If the user fails to make the call on the assigned day, the link changes in color to yellow when the call is one day overdue. When the call is, for example, more than one day overdue, the link becomes red. This color-coding ensures that users are aware of their obligations and associated status of their obligations. The colors and time periods associated with each color are provided for example only. It is apparent that any color could be used for any number of days for which a call is overdue. Further, it provides for ready retrieval and understanding of information by the account manager, who is able to log on to view the lower-level user's account console 200.

The system 10 of the invention can provide point and click access (i.e., hyperlinks) to a number of third-party databases and online resources. The system stores all passwords for third-party resources in one place to ensure that all users can readily access the resources. Storing information related to all third-party resources in one location allows management to easily assess the services to which the organization currently subscribes and more easily make decisions about new subscription options.

As noted in the call reporting and alert notification discussion above, the system includes call report categorization capability. The account manager can utilize the create status report option under the call report menu to pull all call reports tagged to a given client/project/internal customer within a particular month. All calls associated with the client/project/internal customer are grouped by activity category. From this point, the account manager merely has to edit the data into a call report. No re-keying or structuring is required.

The system 10 of the invention includes a reference library of template documents. As discussed above, the reference library is accessible from the account console 200 via the reference library link 240. The reference library provides all users a point-and-click link to template documents that are widely used within the agency to ensure quality and consistency of work product.

The invention stores all users' contact information—home address, telephone number, mobile telephone etc. This section is accessible to all users via the employee information link 270. The system can also include all HR and benefits policies and related forms accessible through the human resources link 292.

The invention facilitates centralized agency-/department-wide scheduling and enables all employees to view one another's schedules from any browser via the schedules link 280. Staff members can point and click to the scheduling component from the account console menu bar to review colleagues' schedules and schedule meetings. The system 10 is configured to link/synchronize with known commercial scheduling tools.

The invention enables time tracking and budget management via the timesheets link 260 of the account console 200. The on-line timesheets prompt users to log their time against accounts/projects/internal customers and activity categories. The users select accounts and categories via pull-down menus. The system allows the manager to view time accrued by account/project/internal customer and user in real-time. This removes the requirement for the accounting department to pull figures for the account managers to manage their budgets. The goal is to optimize service levels and guard against uncompensated and/or unbudgeted service.

The invention provides centralized client/project and billing information. Accessible via the client link 220 of the account console 200, this component allows users to enter required new client/project/internal customer information. The system can automatically e-mail the accounting department with a notification of such an update. The accounting department can then establish appropriate billing codes and alerts the administrator who sets up the client in the system—adding to the client pull-down menu, etc.

The system is configured for an agency environment, or for use in-house in single or multi-employee corporate departments where the public relations function has to track time budgets to specific cost centers. The system functionality allows users to manage budgets on their accounts, counsel clients such as to optimize resource allocation on the account, and recognize accounts over service in real time. The organization loads each employee's billable rate via a simple populate and drop down menu select form. Further, the system prompts the organization to note the monthly budget for each account. As such, when staff members load their time into the daily timesheet component, the system automatically calculates the current budget expenditure relative to the total available budget on the account. The system automatically sends an alert to the account manager as soon as the expended value of time exceeds the allotted monthly budget. This allows the manager to alert the client that they have exhausted the monthly budget. At this juncture, the client can elect to allocate additional budget or to shut down the program until the new budget comes on line. The system's alerting function is fully customizable. Organizations can set thresholds such that the manager is alerted of the current budget “burn” rate mid-month, or at any time interval during the performance period. Further, the organization can set alert thresholds such that the manager is alerted when 50 percent of the budget is exhausted, or at any other level deemed appropriate. This flexibility allows the system to conform to any agency's operating approach.

The invention is designed for an agency environment or sophisticated in-house corporate environment where departments charge back time to in-house customers and projects, this reporting function automatically calculates the billable/non-billable ratio of each employee on a monthly basis. It forwards reports to both the manager and the specific employee. Such information is critical to managing the staff workforce to meet agency productivity and revenue targets. It has direct applicability in human resource, performance review arena.

The invention provides a wireless solution based on, for example, the PALM VII™ platform. Using this approach, the user can log onto the public relations software application as though using a desktop or notebook device. The wireless device presents the user with a “wireless” account console 200. The invention is able to deliver access to all of the system's services from the wireless device.

The web-based system for managing public relations of the present invention is realized in software installed on both a server platform and a client platform. Any kind of computer system or other apparatus adapted for carrying out the methods described herein is suited. In this context, a computer program is provided on a server computer and a thin client software application is installed on a personal computer, laptop or wireless device. When loaded and executed, the program controls the web-based server computer such that it carries out the methods described herein. The web-based system can be embedded as processor-executable code in a processor program product, which includes all the features enabling the implementation of the methods described herein, and which, when loaded in a processor-based system, is able to carry out these methods.

Additionally, the corresponding structures, materials, acts, and equivalents of all elements in any claims are intended to include any structure, material or acts for performing the functions in combination with other claim elements as specifically claimed.

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalence.

The previous description of the embodiments is provided to enable any person skilled in the art to make or use the invention. While the invention has been particularly shown and described with reference to embodiments thereof, it will be understood by those skilled in art that various changes in form and details may be made therein without departing from the spirit and scope of the invention.

What is claimed is:

1. A method, comprising:
generating a public relations database configured to store public relations information, the information related to at least two of clients, employees, employee schedules, contacts, call reports and employee timesheets;
creating a user interface configured to enable a user to at least one of enter, edit, search and view the information; and
populating a plurality of editorial opportunity matrices based on the information.

2. The method of claim 1, wherein the editorial opportunity matrices are based on a rules-based lead time capability.

3. The method of claim 2, wherein a pitch date is automatically assigned based on an entered publication issue date.

4. The method of claim 1, further comprising
assigning a staff member as being responsible for a specific publication corresponding to an editorial opportunity.

5. The method of claim 4, wherein an indication of a call associated with an editorial opportunity is transmitted to a graphical user interface of the assigned staff member, the indication being color-coded.

6. The method of claim 5, wherein the color-code associated with the call changes color based on a reference date.

7. The method of claim 1, further comprising enabling remote access to the database.

8. The method of claim 1, further comprising enabling wireless access to the database.

9. A processor-readable medium storing code representing instructions to cause a processor to:
generate a public relations database configured to store information, the information related to at least two of clients, employees, employee schedules, contacts, call reports and employee timesheets;
create a user interface configured to enable a user to at least one of enter, edit, search and view the information; and
populate a plurality of editorial opportunity matrices based on the information.

10. A system, comprising:
a public relations database configured to store information, the information related to at least two of clients, employees, employee schedules, contacts, call reports and employee timesheets;
a user interface configured to enable a user to at least one of enter, edit, search and view the information; and
an editorial opportunity database configured to be populated based on the information.

11. The system of claim 10, wherein the user interface is implemented on a wireless interface.

12. The system of claim 10, wherein the user interface is configured to access at least one of the public relations database and the editorial opportunity database via the Internet.

13. The system of claim 10, wherein the user interface is implemented on a computer local to the public relations database.

14. The system of claim 10, wherein access to the information is limited based on an authorization level of a user.

15. The system of claim 10, wherein access to the information is limited based on an authorization level of a user interface.
